(19) United States
(12) Patent Application Publication
(10) Pub. No.: US 2026/0213591 A1
(43) Pub. Date: Jul. 23, 2026

(54) INTERIOR PERMANENT MAGNET ROTOR

(71) Applicant: ISUZU MOTORS LIMITED, Yokohama-shi (JP)

(72) Inventor: Yusuke TAKAHASHI, Fujisawa-shi (JP)

(21) Appl. No.: 19/417,882

(22) Filed: Dec. 12, 2025

(30) Foreign Application Priority Data
Jan. 20, 2025 (JP) 2025-007548

(51) Int. Cl. H02K 1/27

(52) U.S. Cl. CPC H02K 1/27

(57) ABSTRACT

A rotor includes: a rotor core having a plurality of magnet insertion holes into which magnets are inserted, a plurality of non-magnetic material insertion holes communicating in the radial direction with an inner end of each of the plurality of magnet insertion holes, and into which a flux barrier is inserted, and a void section provided between adjacent non-magnetic material insertion holes and communicating with the non-magnetic material insertion holes; a first yoke and a second yoke provided movably along an inner wall surface of the void section; and an elastic member provided inside the void section and pressing the first yoke and the second yoke inward in the radial direction of the rotor core.

### CROSS-REFERENCE TO RELATED APPLICATIONS

The present application claims priority to Japanese Patent Application number 2025-007548, filed on Jan. 20, 2025, contents of which are incorporated herein by reference in its entirety.

### BACKGROUND OF THE INVENTION

The present disclosure relates to an interior permanent magnet rotor. A rotor of a conventional interior permanent magnet synchronous motor is provided with a hole for preventing magnetic flux leakage, the hole being formed from an end of a magnet insertion hole in the circumferential direction to a bridge located in the rotor close to its outer peripheral portion, thereby preventing magnetic short-circuiting in the rotor (e.g., Japanese Unexamined Patent Application Publication No. 2014-87074).

A rotor becomes less prone to magnetic flux leakage within the rotor as a radial width of its bridge is reduced, allowing a greater amount of magnetic flux to interlink with a coil. However, since an induced voltage is generated in the coil, it becomes difficult to allow current to flow in the coil. To address this issue, it is conceivable to employ the field weakening control. However, when a rotational speed of the rotor is increased by the field weakening control, the amount of current that does not contribute to rotor rotation increases, resulting in greater loss (copper loss).

### BRIEF SUMMARY OF THE INVENTION

The present disclosure focuses on this point, and an object thereof is to increase a rotational speed of a rotor while suppressing loss.

An interior permanent magnet rotor according to the present disclosure includes: a rotor core having i) a plurality of magnet insertion holes formed at predetermined intervals in a circumferential direction, each of which has a magnet inserted therein, ii) a plurality of non-magnetic material insertion holes communicating in a radial direction with an inner end of each of the plurality of magnet insertion holes, and into which a non-magnetic material is inserted, and iii) a plurality of void sections provided between two adjacent non-magnetic material insertion holes and communicating with the two non-magnetic material insertion holes; a first yoke and a second yoke provided inside each of a plurality of void sections so as to be movable along an inner wall surface of the void section; and an elastic member provided inside each of a plurality of void sections and pressing the first yoke and the second yoke inward in the radial direction of the rotor core.

### BRIEF DESCRIPTION OF THE DRAWINGS

FIG. 1 is a diagram illustrating an overview of a rotor 1.

FIG. 2 is a diagram illustrating the shape of a void section 13.

FIG. 3 is a diagram illustrating a configuration of the void section 13.

FIG. 4 is a cross-sectional view of the rotor 1 taken along a plane in the axial direction of a rotational shaft 2.

FIG. 5 is a diagram illustrating a configuration of the void section 13 in which an elastic member 15 is most compressed.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Overview of a Rotor 1

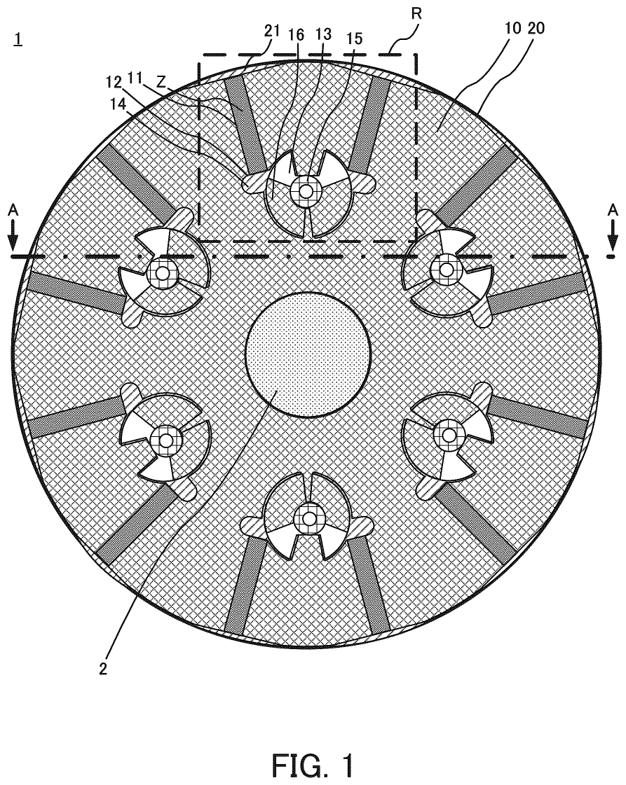

FIG. 1 is a diagram illustrating an overview of a rotor 1. FIG. 1 is a cross-sectional view of the rotor 1 taken along a plane orthogonal to an axial direction of a rotational shaft 2 of an interior permanent magnet synchronous motor. The rotor 1 is disposed outside the rotational shaft 2 and inside a stator (not shown), and is a rotor that has a plurality of magnets Z embedded therein. The rotor 1 includes a rotor core 10, and the rotor core 10 includes a plurality of magnet insertion holes 11, a plurality of non-magnetic material insertion holes 12, and a plurality of void sections 13. In FIG. 1, only one magnet Z out of the plurality of magnets Z, one magnet insertion hole 11 out of the plurality of magnet insertion holes 11, one non-magnetic material insertion hole 12 out of the plurality of non-magnetic material insertion holes 12, and one void section 13 out of the plurality of void sections 13 are denoted by reference numerals.

The rotor core 10 is formed in a cylindrical shape by stacking a ring-shaped magnetic material in the axial direction (the depth direction of the plane of FIG. 1), and is provided to be rotatable in a rotation direction (circumferential direction) of the rotational shaft 2. The plurality of magnet insertion holes 11 are formed at predetermined intervals in the circumferential direction, and the magnets Z are inserted therein. Each magnet insertion hole 11 is formed so as to extend in the axial direction in a rectangular shape elongated in the radial direction of the rotor 1, and the magnet Z having the same shape and size as the magnet insertion hole 11 is embedded in each magnet insertion hole 11. Each magnet Z is inserted into a respective magnet insertion hole 11 so that the radially outer end surface of the magnet Z is exposed from the outer peripheral surface of the rotor core 10.

The plurality of non-magnetic material insertion holes 12 communicate in the radial direction of the rotor core 10 with the inner end of each of the plurality of magnet insertion holes 11, and a non-magnetic material (flux barrier 14) is inserted therein. The non-magnetic material is, for example, a resin material, and is preferably a non-conductive material. Each non-magnetic material insertion hole 12 is formed so that the circumferential length of the surface in contact with the magnet insertion hole 11 is longer than the circumferential length of the magnet insertion hole 11. One of the two surfaces of each of the non-magnetic material insertion holes 12 along the radial direction of the rotor core 10 is formed so as to extend in the axial direction along a semicircular arc, and the other is formed so as to communicate with the void section 13.

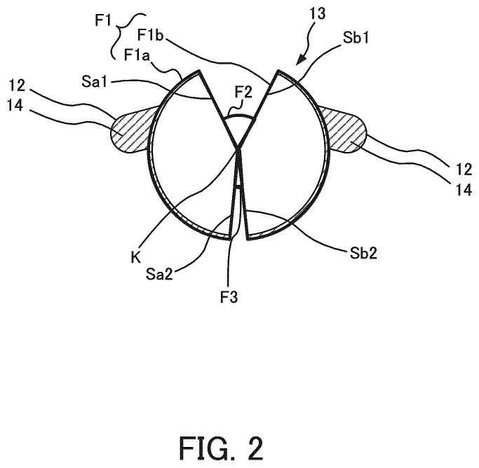

The plurality of void sections 13 are provided between two adjacent non-magnetic material insertion holes 12, and communicate with the two non-magnetic material insertion holes 12. FIG. 2 is a diagram illustrating the shape of the void section 13. FIG. 2 is an enlarged view of the void section 13 and the non-magnetic material insertion hole 12 included in a portion R of the rotor 1 shown in FIG. 1. Each void section 13 includes two first void portions F1 (F1a, F1b), which intersect along a line extending in the axial direction from an intersection point K, a second void portion F2, and a third void portion F3. The cross-sectional shapes of the first void portions F1, the second void portion F2, and the third void portion F3, each cut by a plane orthogonal to the axial direction of the rotational shaft 2, are sectorial.

The first void portions F1 are formed so as to extend in the axial direction with a sector-shaped cross section having a larger radius than the cross sections of the second void portion F2 and the third void portion F3. The first void portion F1a and the first void portion F1b have the same shape and size. The second void portion F2 is formed so as to extend in the axial direction with a sector-shaped cross section having a smaller radius than the cross section of the first void portions F1 and larger than the cross section of the third void portion F3. The second void portion F2 is located on the radially outer side of the intersection point K in the rotor core 10 so as to connect the two first void portions F1. The third void portion F3 is formed so as to extend in the axial direction with a sector-shaped cross section having a smaller radius than the cross sections of the first void portions F1 and the second void portion F2. The third void portion F3 is located on the radially inner side of the intersection point K in the rotor core 10 so as to connect the two first void portions F1.

In each void section 13, a flat surface Sa1 and a flat surface Sa2 extending in the axial direction of the first void portion F1a, and a flat surface Sb1 and a flat surface Sb2 extending in the axial direction of the first void portion F1b, are formed. In each void section 13, the flat surface Sa1 and the flat surface Sb1 are located so as to face each other in the circumferential direction of the rotor core 10, and the flat surface Sa2 and the flat surface Sb2 are located so as to face each other in the circumferential direction of the rotor core 10. In each void section 13, the center angle of the second void portion F2 in the circumferential direction is larger than the center angle of the third void portion F3 in the circumferential direction. In each void section 13, the second void portion F2 and the third void portion F3 are located so as to face each other in the radial direction of the rotor core 10.

In each of the void sections 13, the flux barrier 14 inserted into the non-magnetic material insertion hole 12 is formed so as to extend along the inner wall surface of the void section 13. In each void section 13, an elastic member 15 and two yokes 16 are inserted. Hereinafter, a configuration of the void section 13 will be described in detail.

### Configuration of the Void Section 13

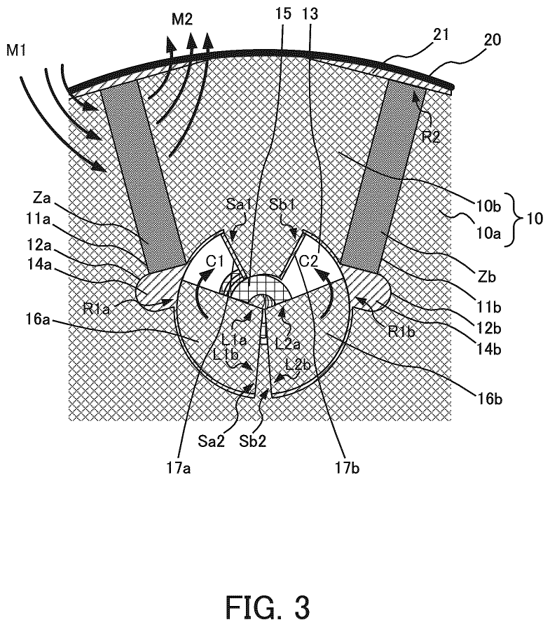

FIG. 3 is a diagram illustrating a configuration of the void section 13. FIG. 3 is an enlarged view of the portion R of the rotor 1 shown in FIG. 1. FIG. 3 shows the configuration of the void section 13 when the rotational speed of the rotor 1 is equal to or lower than a base rotational speed. The base rotational speed is the maximum value of the rotational speed at which the rotor 1 can rotate without executing the field weakening control, and is a fixed value between 3000 rpm and 5000 rpm, for example. FIG. 3 shows a magnetic flux M1 advancing from the radially outer side (i.e., stator) of the rotor 1 to a magnet Za and a magnetic flux M2 advancing from the magnet Za to the radially outer side of the rotor 1.

In the void section 13, the elastic member 15, a first yoke 16a, and a second yoke 16b are inserted. In the void section 13, the first yoke 16a, the elastic member 15, and the second yoke 16b are inserted in this order from the side close to the non-magnetic material insertion hole 12a in the circumferential direction of the rotor core 10.

The elastic member 15 is a spring formed of a non-magnetic material, and is, for example, a return spring. As one example, the non-magnetic material is stainless steel. The elastic member 15 is provided inside each of the plurality of void sections 13, and presses the first yoke 16a and the second yoke 16b inward in the radial direction of the rotor core 10. Specifically, one end of the elastic member 15 presses the first yoke 16a in a direction opposite to the direction C1, and the other end of the elastic member 15 presses the second yoke 16b in a direction opposite to the direction C2.

The elastic member 15 presses, for example, one flat surface located on the radially outer side of the rotor core 10 among the two flat surfaces extending in the axial direction of each of the first yoke 16a and the second yoke 16b. Specifically, one end of the elastic member 15 presses a flat surface L1a among two flat surfaces L1a and L1b of the first yoke 16a, and the other end of the elastic member 15 presses a flat surface L2a among two flat surfaces L2a and L2b of the second yoke 16b.

As a result of a centrifugal force generated by the rotation of the rotor 1 and acting on the first yoke 16a and the second yoke 16b, the elastic member 15 is pressed and contracts in the directions C1 and C2. Therefore, spring characteristics (for example, spring constant and set load) of the elastic member 15 are determined so that the elastic member 15 contracts when the rotational speed of the rotor 1 is equal to or higher than a predetermined rotational speed (for example, base rotational speed). By having the elastic member 15 configured in this manner, the rotational speed of the rotor 1 at which the first yoke 16a and the second yoke 16b start to move can be adjusted by the first yoke 16a and the second yoke 16b pressing the elastic member 15.

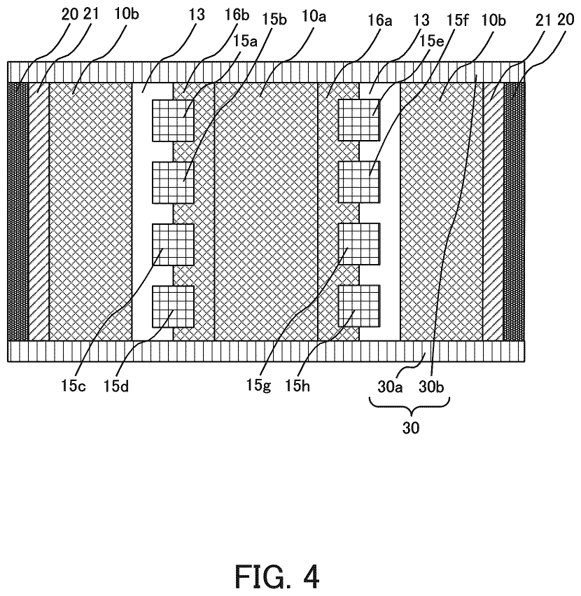

The elastic member 15 may be divided into a plurality of pieces in the axial direction of the rotor core 10. FIG. 4 is a cross-sectional view of the rotor 1 taken along a plane in the axial direction of the rotational shaft 2. FIG. 4 shows an A-A cross-sectional view of the rotor 1 shown in FIG. 1. In the rotor 1 shown in FIG. 4, end plates 30 (30a, 30b) are provided at both ends of the rotor core 10 in the axial direction. As an example, in FIG. 4, one of the two elastic members 15 is divided into elastic members 15a, 15b, 15c, and 15d, and the other elastic member 15 is divided into elastic members 15e, 15f, 15g, and 15h.

Each divided elastic member 15 (elastic members 15a, 15b, 15c, 15d, and elastic member 15e, 15f, 15g, 15h) is positioned so as not to move in the axial direction. Specifically, the second yoke 16b extending in the circumferential direction is formed between the elastic members 15a, 15b, 15c, and 15d so that the elastic members 15a, 15b, 15c, and 15d do not move in the axial direction. Similarly, the first yoke 16a extending in the circumferential direction is formed between the elastic members 15e, 15f, 15g, and 15h so that the elastic members 15e, 15f, 15g, and 15h do not move in the axial direction.

The greater the number of divisions that divides the elastic member 15, the smaller the force that presses the first yoke 16a and the second yoke 16b becomes. Therefore, by dividing the elastic member 15 into the plurality of elastic members 15 as described above, the number of divisions of the elastic member 15 can be determined in such a manner that the elastic member 15 contracts at a predetermined rotational speed of the rotor 1.

Furthermore, the spring characteristics of each elastic member 15 may be determined according to the distance from the end plates 30. That is, the spring characteristics of each divided elastic member 15 (elastic members 15a, 15b, 15c, 15d and elastic members 15e, 15f, 15g, 15h) are determined according to the distance from the end plates 30 provided at the axial ends of the rotor core 10. For example, the elastic member 15a and the elastic member 15d may use elastic members having the same spring characteristics, and the elastic member 15b and the elastic member 15c may use elastic members having the same spring characteristics, which may differ from those of the elastic members 15a and 15d.

Returning to FIG. 3, the first yoke 16a and the second yoke 16b are formed so as to extend in the axial direction of the rotor core 10 by stacking sector-shaped magnetic materials, and are located so as to face each other in the circumferential direction of the rotor core 10. The magnetic material is the same as the magnetic material that forms the rotor core 10, and is, for example, an electromagnetic steel sheet. In the first yoke 16a shown in FIG. 3, the flat surface L1b, which is located on the radially inner side of the rotor core 10 among the two flat surfaces extending in the axial direction of the first yoke 16a, is positioned to contact the flat surface Sa2 of the void section 13. In the second yoke 16b shown in FIG. 3, the flat surface L2b located on the radially inner side of the rotor core 10 among the two flat surfaces extending in the axial direction of the second yoke 16b is positioned to contact the flat surface Sb2 of the void section 13.

With this configuration, between a rotor core 10a and a rotor core 10b shown in FIG. 3, a portion where the magnetic flux is impeded is formed by a portion of the void section 13 where the yoke 16 is not inserted and by the flux barrier 14. As a result, when the rotational speed of the rotor 1 is less than the base rotational speed, the magnetic flux advancing from the magnet Za to its radially inner side via the rotor core 10b can be suppressed (that is, it is possible to suppress the generation of leakage magnetic flux).

The first yoke 16a and the second yoke 16b are provided inside each of the plurality of void sections 13 so as to be movable along the inner wall surfaces of the void sections 13. The centrifugal force generated by the rotation of the rotor 1 acts on the first yoke 16a and the second yoke 16b, causing them to press the elastic member 15. When the rotation of the rotor 1 reaches or exceeds the base rotational speed, the first yoke 16a and the second yoke 16b press the elastic member 15 with a force greater than the force with which the elastic member 15 presses the first yoke 16a and the second yoke 16b, causing the elastic member 15 to contract and the yokes to move. In this case, the first yoke 16a moves in the direction C1, and the second yoke 16b moves in the direction C2.

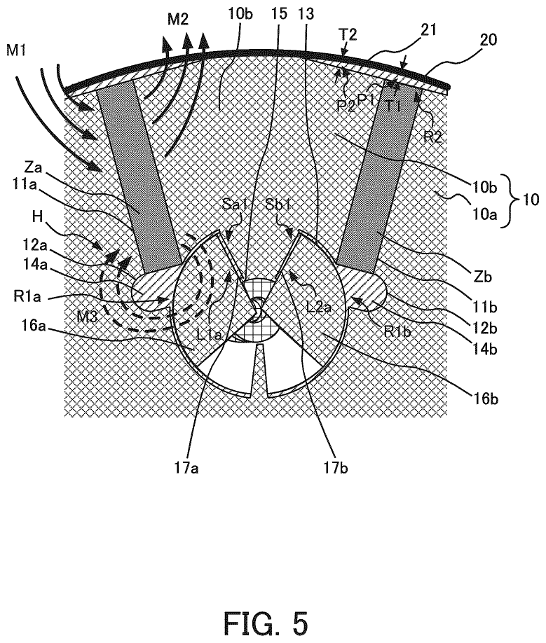

FIG. 5 is a diagram illustrating a configuration of the void section 13 in which the elastic member 15 is most compressed. FIG. 5 shows the first yoke 16a and the second yoke 16b in the case of high-speed rotation when the rotational speed of the rotor 1 is equal to or higher than the base rotational speed (for example, 15000 rpm). The first yoke 16a moves to a position where the flat surface L1a of the first yoke 16a is in contact with the flat surface Sa1 of the void section 13. The second yoke 16b moves to a position where the flat surface L2a of the second yoke 16b is in contact with the flat surface Sb1 of the void section 13.

Since the first yoke 16a and the second yoke 16b move in this manner, for example, in the first yoke 16a, the magnetic flux M3 advances from the magnet Za to the rotor core 10a via the rotor core 10b and the first yoke 16a. Accordingly, the magnetic flux M3 can bypass the flux barrier 14 and be directed toward the surface of the magnet Za opposite to the surface where the magnetic flux M3 is generated. As a result, in the rotor 1, since the magnetic flux amount of the leakage magnetic flux increases during high-speed rotation when the rotational speed is equal to or higher than the base rotational speed, it is possible to suppress the execution of the field weakening control. Furthermore, by suppressing the execution of the field weakening control, loss (copper loss) can be reduced.

The void section 13 may include a thin plate member formed of a non-magnetic material on an inner wall surface that contacts the first yoke 16a or the second yoke 16b when the elastic member 15 contracts to the maximum according to the rotation of the rotor core 10. The non-magnetic material is the same material as the flux barrier 14, and is, for example, a resin material. The thickness of the thin plate member is, for example, 1 mm. As shown in FIG. 5, the void section 13 has, for example, a thin plate member 17a on the flat surface Sa1 in contact with the first yoke 16a, and a thin plate member 17b on the flat surface Sb1 in contact with the second yoke 16b. With this configuration, it is possible to suppress the magnetic flux advancing from the rotor core 10b to the first yoke 16a and the second yoke 16b, thereby allowing the first yoke 16a and the second yoke 16b to move more easily when the rotational speed of the rotor 1 decreases.

It should be noted that one of the two flux barriers 14 (flux barrier 14a) inserted into two adjacent non-magnetic material insertion holes 12 is in contact with an outer peripheral surface R1a along the axial direction of the first yoke 16a. The other of the two flux barriers 14 (flux barrier 14b) inserted into the two adjacent non-magnetic material insertion holes 12 is in contact with an outer peripheral surface R1b along the axial direction of the second yoke 16b. Furthermore, in the void section 13, the flux barrier 14a is formed so as to extend along the inner wall surface of the outer peripheral surface R1a, and the flux barrier 14b is formed so as to extend along the inner wall surface of the outer peripheral surface R1b.

As described above, since the flux barriers 14 inserted into the non-magnetic material insertion holes 12 are formed so as to be in contact with the outer peripheral surface R1a and the outer peripheral surface R1b, the rotor 1 impedes the magnetic flux from advancing to the radially inner side of the magnet Z during low-speed rotation when the rotational speed of the rotor 1 is less than the base rotational speed. As a result, leakage magnetic flux from the magnet Z can be suppressed. Furthermore, during high-speed rotation when the rotational speed of the rotor 1 is equal to or higher than the base rotational speed, the rotor 1 can advance the generated leakage magnetic flux toward the surface of the magnet Z opposite to the surface where the leakage magnetic flux is generated.

The radially outer end surface R2 of the magnet Z is inserted so as to be exposed from the outer peripheral surface of the rotor core 10a. The rotor core 10b is not connected to the rotor core 10a. Therefore, when the centrifugal force generated by the rotation of the rotor 1 acts, the magnet Z, the rotor core 10b, and the elastic member 15 may move outward in the radial direction away from the rotor 1. Therefore, the rotor 1 may further include, on the radially outer side of the rotor core, a sealing member 20 that covers the outer peripheral surface of the rotor core 10. The sealing member 20 is formed of, for example, CFRP (Carbon Fiber Reinforced Plastics). By providing the sealing member 20 in this manner, it is possible to prevent the magnet Z, the rotor core 10b, and the elastic member 15 from moving away from the rotor 1 due to the centrifugal force.

The rotor 1 may further include, between the outer peripheral surface of the rotor core 10 and the sealing member 20, a non-magnetic member 21 formed of a non-magnetic material. The non-magnetic member 21 is, for example, formed using a resin material in the same manner as the flux barrier 14. The thickness of the non-magnetic member 21 in the radial direction may be increased as the distance, in the circumferential direction of the rotor core 10, to the radially outer end surface R2 of the magnet Z decreases. For example, the thickness T1 of the non-magnetic member 21 in the radial direction at the position P1 shown in FIG. 5 is greater than the thickness T2 of the non-magnetic member 21 in the radial direction at the position P2.

The magnetic flux advancing from the magnet Z to the stator tends to pass more easily through a position (i.e., the so-called center of the pole) closer to the radially outer end surface R2 of the magnet Z. Therefore, by having the rotor 1 configured in this manner, the thickness of the non-magnetic member 21 provided between the rotor 1 and the stator becomes greater at positions closer to the center of the pole, so that the magnetic flux advancing from the magnet Z toward the stator tends to pass through portions where the thickness of the non-magnetic member 21 is smaller (portions farther from the end surface R2). As a result, the variation in the positions of the magnetic flux advancing from the rotor 1 toward the stator can be reduced.

Furthermore, since the radially outer end surface R2 of the magnet Z is exposed, the magnet Z presses the sealing member 20 due to the centrifugal force acting on the rotor 1. Since the area of the end surface R2 is smaller than the area of the outer peripheral surface of the rotor core 10b, when the non-magnetic member 21 is not present, the magnet Z is more likely than the rotor core 10b to damage the sealing member 20 by pressing it. Therefore, by having the rotor 1 configured in this manner, the thickness of the non-magnetic member 21 can be increased at positions where the sealing member 20 is more likely to be damaged, thereby making the sealing member 20 less prone to damage.

### Effect of the Rotor 1

As described above, the rotor 1 includes: the rotor core 10 having (i) the plurality of magnet insertion holes 11 formed at predetermined intervals in the circumferential direction, and into which the magnets Z are inserted, (ii) the plurality of non-magnetic material insertion holes 12 communicating, in the radial direction, with the inner end of each of the plurality of magnet insertion holes 11, and into which the flux barrier 14 is inserted, and (iii) the void section 13 provided between two adjacent non-magnetic material insertion holes 12 and communicating with the two non-magnetic material insertion holes 12; the first yoke 16a and the second yoke 16b are provided inside each of the plurality of void sections 13 so as to be movable along the inner wall surface of the void sections 13; and the elastic member 15 is provided inside each of the plurality of void sections 13 and presses the first yoke 16a and the second yoke 16b inward in the radial direction of the rotor core 10.

By having the rotor 1 configured in this manner, during low-speed rotation when the rotational speed of the rotor 1 is less than the base rotational speed, the magnetic flux advancing from the magnet Z to its radially inner side via the rotor core 10 (that is, the generation of leakage magnetic flux) can be suppressed. Furthermore, during high-speed rotation when the rotational speed of the rotor 1 is equal to or higher than the base rotational speed, the magnetic flux advances from the magnet Z so as to bypass the flux barrier 14, and be directed toward the surface of the magnet Z, in the circumferential direction, opposite to the surface where the magnetic flux is generated, thereby increasing the magnetic flux amount of the leakage magnetic flux. As a result, since the rotor 1 can suppress the execution of the field weakening control, loss (copper loss) can be reduced.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. An interior permanent magnet rotor comprising:
a rotor core having i) a plurality of magnet insertion holes formed at predetermined intervals in a circumferential direction, each of which has a magnet inserted therein, ii) a plurality of non-magnetic material insertion holes communicating in a radial direction with an inner end of each of the plurality of magnet insertion holes, and into which a non-magnetic material is inserted, and iii) a plurality of void sections provided between two adjacent non-magnetic material insertion holes and communicating with the two non-magnetic material insertion holes;
a first yoke and a second yoke provided inside each of a plurality of void sections so as to be movable along an inner wall surface of the void section; and
an elastic member provided inside each of a plurality of void sections and pressing the first yoke and the second yoke inward in the radial direction of the rotor core.

2. The interior permanent magnet rotor according to claim 1, wherein the first yoke and the second yoke are formed so as to extend in an axial direction of the rotor core by stacking sector-shaped magnetic materials, and are located so as to face each other in a circumferential direction of the rotor core.

3. The interior permanent magnet rotor according to claim 2, wherein the elastic member is formed of a non-magnetic material, and presses one flat surface located on a radially outer side of the rotor core among the two flat surfaces extending in the axial direction of each of the first yoke and the second yoke.

4. The interior permanent magnet rotor according to claim 3, wherein one of the two non-magnetic materials inserted into two adjacent non-magnetic material insertion holes is in contact with an outer peripheral surface along the axial direction of the first yoke, and the other is in contact with an outer peripheral surface along the axial direction of the second yoke.

5. The interior permanent magnet rotor according to claim 1, wherein the void section includes a thin plate member formed of a non-magnetic material on an inner wall surface that contacts the first yoke or the second yoke when the elastic member contracts to the maximum according to the rotation of the rotor core.

6. The interior permanent magnet rotor according to claim 1, wherein the magnet Z is inserted into the magnet insertion hole so that a radially outer end surface of the magnet Z is exposed from an outer peripheral surface of the rotor core, and
a sealing member that covers the outer peripheral surface of the rotor core is further provided on a radially outer side of the rotor core.

7. The interior permanent magnet rotor according to claim 6, further comprising:
a non-magnetic member formed of a non-magnetic material and provided between the outer peripheral surface of the rotor core and the sealing member.

8. The interior permanent magnet rotor according to claim 7, wherein a thickness of the non-magnetic member in the radial direction increases as a distance, in the circumferential direction of the rotor core, to the radially outer end surface of the magnet Z decreases.

9. The interior permanent magnet rotor according to claim 1, wherein the non-magnetic material insertion hole is formed so that a circumferential length of a surface in contact with the magnet insertion hole is longer than a circumferential length of the magnet insertion hole.

10. The interior permanent magnet rotor according to claim 1, wherein the elastic member is divided into a plurality of pieces in an axial direction of the rotor core, and spring characteristics of each of the divided elastic members are determined according to a distance from end plates provided at axial ends in the axial direction of the rotor core.
